(19) United States
(12) Patent Application Publication
(10) Pub. No.: US 2023/0089963 A1
(43) Pub. Date: Mar. 23, 2023

(54) Electrical Infrastructure Installation Bracket

(71) Applicant: Anthony Joseph Orlando, Ruskin, FL (US)

(72) Inventor: Anthony Joseph Orlando, Ruskin, FL (US)

(73) Assignee: Anthony Joseph Orlando, Ruskin, FL (US)

(21) Appl. No.: 17/950,051

(22) Filed: Sep. 21, 2022

Related U.S. Application Data
(60) Provisional application No. 63/246,323, filed on Sep. 21, 2021.

(51) Int. Cl. F16L 5/00

(52) U.S. Cl. CPC F16L 5/00

(57) ABSTRACT

A bracket that can be used to run electrical wires, mostly low voltage, during construction when devices or finished structures are not yet installed. The bracket can be mounted to in-wall, in-ceiling and other structures to provide a finished location to terminate caballing before finishes are installed. Cable can be temporarily affixed to the bracket to prevent unwanted movement and plugged during trim-out if not needed.

### BACKGROUND

The current art of electrical infrastructure installation is to install “back boxes” during the preconstruction phase. The back boxes tend to be electrical boxes or low voltage rings in the single to multi gang configurations. Some situations do not facilitate using a gang style box, especially for low voltage, during the installation of, but not limited to Wireless Access Point, Closed Circuit Television Cameras, Touchscreens, Control Devices, Speakers, etc.

The following are disadvantages of the current art.
1. Using a single gang back box is often too large for the intended device to be installed. This will cause the installed to use and modify a blank wall plate, often being seen underneath the device once installed.
2. During pre-wire when not using an installation bracket cable is coiled and attached to structure using tie straps. This cable is usually damaged or inadvertently relocated during wall/ceiling structure installation rendering the cable unable to be found or useless.

The following are advantages of the Electrical Infrastructure Installation Bracket
1. The bracket can be installed to any structure in any orientation to provide rough-in location for cable allowing a definitive location for other trades to work around.
2. Cable can be affixed to the bracket to avoid damage or inadvertent relocation by other trades during trim-out.
3. The bracket is small enough to be covered by most/all devices during final installation providing a better aesthetic. if that cable is to be abandoned, it can be covered using a blank plug.

U.S. Pat. No. 9,502,874B2 and U.S. Pat. No. 7,816,604B1 reference the current state of the art in which a lower voltage bracket is in the form of a single or multi gang configuration and there for is unable to provide the same unique advantages of the Electrical Infrastructure Installation Bracket.

U.S. Pat. No. 9,992,389B1 references an adapter socket plate for a camera. This makes the device being used conform to a specific size in order to maintain aesthetic appearance, whereas the Electrical Infrastructure Installation Bracket can be used on any device regardless of size.

### BRIEF SUMMARY OF THE INVENTION

The Electrical Infrastructure Installation Bracket can be used to run electrical wires, mostly low voltage, during construction when devices or finished structures are not yet installed. The bracket can be mounted to in-wall, in-ceiling and other structures to provide a finished location to terminate cabling before finishes are installed. Cable can be temporarily affixed to the bracket to prevent unwanted movement and plugged during trim-out if not needed.

### BRIEF DESCRIPTION OF DRAWING

NOTE: For simplicity of illustration some details, including but not limited to, scale have been omitted from the drawing and are for illustration purposes only.

FIG. 1. is a Top 1 and side 2 view of the of the Electrical Infrastructure Installation Bracket

### DETAILED DESCRIPTION OF INVENTION

The various embodiments and variations thereof illustrated in the accompanying figures and/or described herein and merely exemplary and are not meant to limit the scope of this invention. It is to be appreciated that numerous variations have been contemplated as would be obvious to one of ordinary skill in the art with the benefit of this disclosure. Rather, the scope and breadth afforded this document should only be limited by the claims provided herein while applying either the plain meaning to each of the terms and phrases in the claims of the meaning clearly and unambiguously provided in this specification.

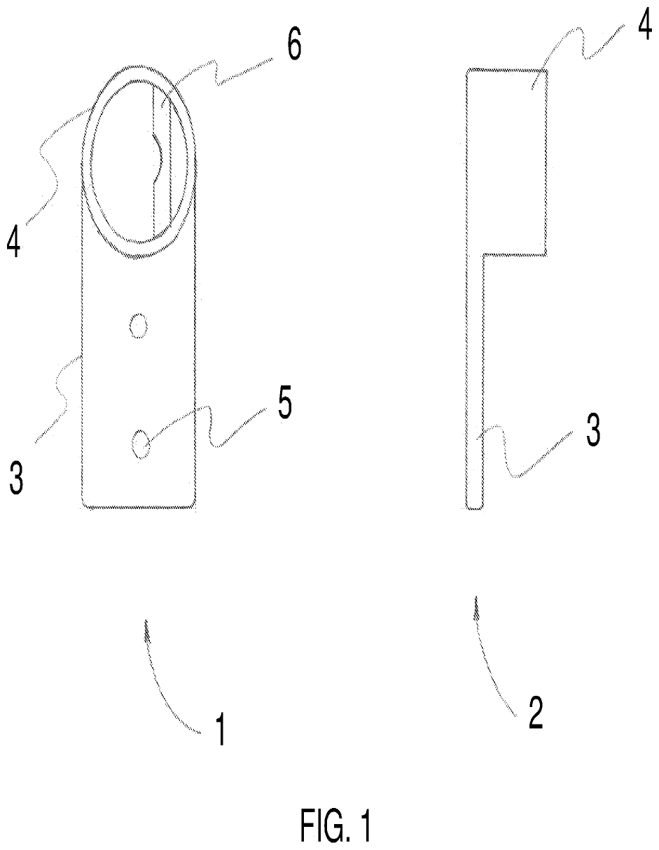

FIG. 1 shows the Electrical Infrastructure Installation Bracket in a top view 1 and a side view 2 and, in itself, is a unique device to solve the above issue in the current state of art. The bracket has a tab 3 that is used for mounting to structure. This tab has multiple fastener holes 5 that once affixed keeps the bracket from moving or spinning. The main body 4 is fixed to the tab and provides a place holder for the device within any finishing surfaces including, but not limited to, drywall, wood, tile, etc., and acts as a conduit for the cable to be roughed into during construction. The cable attachment rail 6 provides a location for the cable to be temporarily affixed before permanent device installation. The overall design of the bracket allows for it to be plugged in the event the device location is not needed during trim-out.

The invention claim is:

1. A bracket with the ability to be used during electrical construction comprising a. a tab with provisions capable of being mounted to structure b. a main body protruding past the structure holding the place of the device in the finished materials, c. a main body that also acts as a conduit for the cable to pass unobstructed through the finished material, d. a cable securing rail
